(19) United States
(12) Patent Application Publication
(10) Pub. No.: US 2005/0092696 A1
(43) Pub. Date: May 5, 2005

(54) Apparatus, system and method for use in backwashing pool filters

(76) Inventor: Donald Stanley Smith, Phoenix, AZ (US)

Correspondence Address: Donald S. Smith, 241 Grovers Avenue, Phoenix, AZ, 85023, US

(21) Appl. No.: 10/979,643

(22) Filed: Nov. 1, 2004

Related U.S. Application Data
(60) Provisional application No. 60/515,613, filed on Oct. 30, 2003.

(51) Int. Cl. B01D 29/62

(52) U.S. Cl. 210/798; 210/169; 210/411

(57) ABSTRACT

Apparatus for use in backwashing pool filters. The apparatus includes a resiliently-flexible backwash hose that tends to assume a flattened configuration when empty. A hose spool is provided having a frame having a frame handle, and a reel having a hub mounted for rotation on the frame. The reel includes two flanges extending radially outwardly from the hub, with the flanges being spaced apart to define a channel between the flanges for receiving the hose. A slot is provided in the hub for releasably receiving the end of the flexible hose to allow the hose to be wound on the hub when the reel is turned. A system and method of use, as well as an ornamental design, are also disclosed.

### RELATED APPLICATION

This application claims priority based on U.S. provisional application No. 60/515,613, filed Oct. 30, 2003, Docket No. DS2003/1, the entire contents of which are incorporated herein by reference.

### FIELD

This application relates generally to backwashing pool filters and hose spools, and more particularly, for example, to apparatus, systems and methods for use in backwashing pool filters.

### BACKGROUND

A pool filtering systems are known for filtering water in a pool. Such systems may include a pool filter of the type that may be cleaned by backwashing, such as sand filters and diatomaceous earth (DE) filters. Backwashing is the process of cleaning the filter medium by reversing the flow of water through the filter. Such backwashing may be necessary to clear contaminant clogging the filter, which may otherwise reduce the effectiveness of the filter, diminish the flow of water returning to the pool and increase pressure at the upstream side of the filter media.

Typically, a backwash outlet and a valve are connected in fluid communication with the pool filter. The valve of such systems may have a filtering position in which water is directed from the pool into the pool filter for filtering, and a backwash position in which water flushed backwards through the pool filter is drained through the backwash outlet rather than returned to the pool. The pool pump may propel the backwashed wastewater out through the backwash outlet under substantial pressure.

It is known to have a flexible backwash hose connected to the backwash outlet. Such hoses may have a length measuring, for example, between 25 and 50 feet (7.6 m-15.2 m). The filter is generally considered to be cleaned when the backwashed wastewater leaving the backwash hose is clear or close to the clarity of the pool water.

Typically, backwash hoses are not well managed, and are haphazardly left in a tangled and/or knotted pile either lying on or beside the pool filtering system, resulting in a lengthy process to disperse the hose for backwashing the next time. In addition, the tangled hose pile may leave kinks or knots in the hose tending to accelerate degradation of the hose, and leading to cracks, tears or crimps that reduce the usable life of the hose. Moreover, the pump has been known to create sufficient pressure to burst the backwash hose in a matter of seconds if backwashing is attempted with a backwash hose that is knotted, tangled or crimped enough to stop water flow.

U.S. Pat. Nos. 4,253,716; 4,506,853; 4,588,083; 5,005,790; 5,419,362; 5,634,615; 5,699,987; 5,988,207; 6,059,215; 6,412,676; 6,425,549 and 6,438,792, as well as U.S. patent application Publication Nos. 2002/0074300 and 2002/0074462, are cited herein without admission or prejudice.

### SUMMARY OF EXEMPLARY EMBODIMENTS

Among the several advantages of several of the exemplary embodiments are the provision of a device, system or method for more convenient and time-sensitive deployment, retrieval and storage of backwash hose; the provision of such devices, systems and methods that maintain the tidy organization of such backwash hose and are adapted to help prolong the life of such backwash hose; the provision of such devices, systems and methods that facilitate avoiding knotting, twisting, kinking or otherwise so damaging such hose; and the provision of such devices, systems and methods that are relatively uncomplicated and easy to use.

While the exemplary embodiments are described primarily in connection with a backwash hose used in connection with pool maintenance, it is also contemplated that the invention could usefully and beneficially be applied to other types of hoses.

A first exemplary embodiment is a hose spool for a resiliently-flexible backwash drain hose of the type used to backwash pool filtering systems. The hose spool generally comprises a frame having a frame handle, and a reel having a hub mounted for rotation on the frame. Two flanges extend radially outwardly from the hub, with the flanges being spaced apart to define a channel between the flanges for receiving a hose. The hub has a slot for releasably receiving the end of the flexible hose to allow the hose to be wound on the hub when the reel is turned.

A second exemplary embodiment is an apparatus for use in backwashing pool filters. The exemplary apparatus generally comprises a resiliently-flexible hose that tends to assume a flattened configuration when empty, and a hose spool. The hose spool comprises a frame having a frame handle, and a reel having a hub mounted for rotation on the frame. Two flanges extend radially outwardly from the hub, with the flanges being spaced apart to define a channel between the flanges for receiving the hose. The hub has a slot that releasably receives the end of the flexible hose to allow the hose to be wound on the hub when the reel is turned.

An alternative exemplary aspect based on the first and second exemplary embodiments is to employ the hose spool to manage any flexible hose that tends to assume a flattened configuration when empty.

A third exemplary embodiment is a pool filtering and backwash system for filtering water in a pool. The exemplary system comprises a pool filter of the type that may be cleaned by backwashing, a backwash outlet, and a valve connected to the pool filter. The valve has a filtering position in which water is directed from the pool into the pool filter for filtering, and a backwash position in which water flushed backwards through the pool filter is drained through the backwash outlet rather than returned to the pool. A resiliently-flexible hose is employed that tends to assume a flattened configuration when empty. The resiliently-flexible hose has a captive end attached to the backwash outlet and free end through which water is drained. A hose spool is provided comprising a frame having a frame handle, and a reel having a hub mounted for rotation on the frame. Two flanges extend radially outwardly from the hub, with the flanges being spaced apart to define a channel between the flanges for receiving the hose. The hub has a slot that releasably receives the free end of the hose in its flattened condition to allow the hose to be wound up on the hub from the free end of the hose substantially to its closed end when the reel is turned.

A third exemplary embodiment is a method of backwashing a pool filtering system. The method generally comprises:

(a) Connecting a captive end of a backwash drain hose to the backwash outlet of a pool filtering system having a pool filter that is cleaned by backwashing. The backwash outlet is in fluid communication with the pool filtering system via a valve having a filtering position in which water is directed from the pool into the pool filter for filtering, and a backwash position in which water flushed backwards through the pool filter is drained through the backwash outlet rather than returned to the pool.

(b) Extending the backwash drain hose from the backwash outlet to bring a free end of the backwash drain hose to desirable location for draining water backwashed through the filter.

(c) Switching the valve to its backwash position.

(d) Backwashing water through the filter to clean the filter.

(e) Switching the valve to its filtering position after the filter is cleaned by backwashing water through the filter.

(f) Winding the backwash drain hose on the reel of a hose spool from starting at the free end of the hose substantially to the captive end of the hose.

An alternative embodiment of the method is to use a hose spool to wind any hose from its free end toward a captive end. In a preferred exemplary aspect of this alternative embodiment, the hose spool is employed to facilitate drainage of the hose.

These and other features are described hereinafter.

### BRIEF DESCRIPTION OF THE DRAWINGS

FIG. 1 is a schematic illustration of a pool and exemplary pool filtering and backwash system in its filtering configuration.

FIG. 2 is a schematic illustration of the exemplary pool and pool filtering and backwash system in its backwash configuration.

FIG. 3 is a perspective view of an exemplary embodiment of a hose spool particularly adapted for use in exemplary pool filtering and backwash systems.

FIG. 4 is a front elevation of the exemplary hose spool of FIG. 3.

FIG. 5 is a back elevation of the exemplary hose spool of FIGS. 3 and 4.

FIG. 6 is a left side elevation of the exemplary hose spool of FIGS. 3-5.

FIG. 7 is a right side elevation of the exemplary hose spool of FIGS. 3-6.

FIG. 8 is a top plan view of the exemplary hose spool of FIGS. 3-7.

FIG. 9 is a bottom plan view of the exemplary hose spool of FIGS. 3-8.

FIG. 10 is a front elevation of an alternative exemplary embodiment of a reel and reel handle.

FIG. 11 is a front elevation of a second alternative exemplary embodiment of a reel.

FIG. 12 is a front elevation of a third alternative exemplary embodiment of a reel.

FIG. 13 is a front elevation of a fourth alternative exemplary embodiment of a reel.

FIG. 14 is a perspective view of an exemplary embodiment of hub of a hose spool.

FIG. 15 is a left side elevation of an alternative exemplary embodiment of a hose spool having a wheel mechanism for rolling the hose spool along the ground.

FIG. 16 is a flow diagram of an exemplary method of backwashing a pool filter.

### DETAILED DESCRIPTION OF EXEMPLARY EMBODIMENTS

Exemplary Pool and Pool Filtering/Backwash System

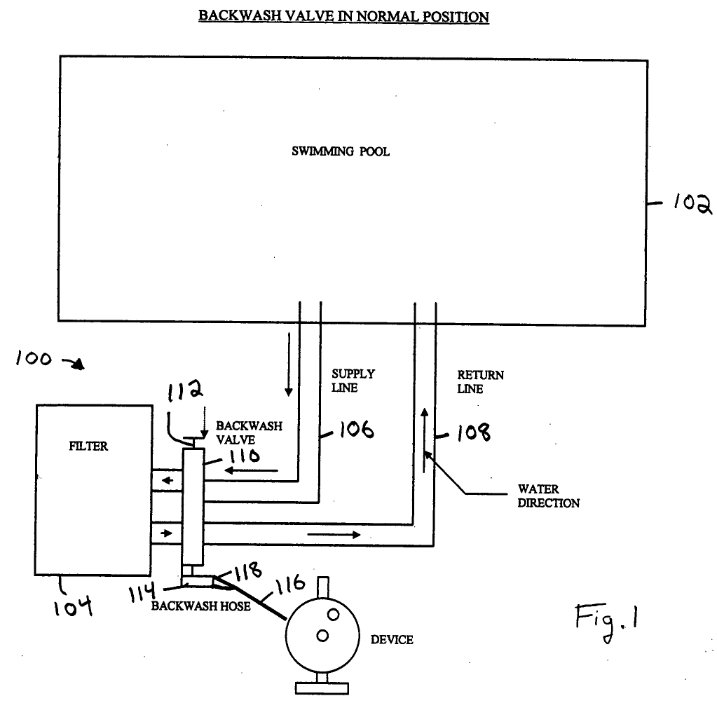

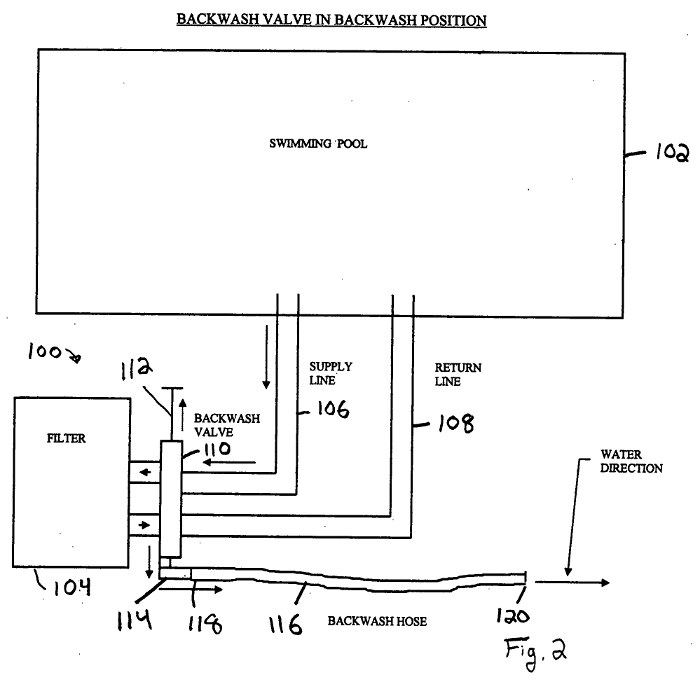

Referring first to FIGS. 1 and 2, an exemplary pool filtering and backwash system is designated in its entirety by reference numeral 100. The system 100 is adapted for filtering water in a pool 102, and includes a pool filter 104 of the type that may be cleaned by backwashing, such as a sand filter or diatomaceous earth (DE) filter. For example, a sand filter 104 may comprise a filter tank filled with sand and gravel. Water is pumped over the top of the sand and forced through the sand.

As illustrated in FIG. 1, water is drained, typically under suction provided by a pump (not shown), from the pool 102 through at least one drain line 106 for filtering by the pool filter 104. After filtering by the pool filter 102, the water is returned to the pool 104 via at least one return line 108.

A valve/manifold mechanism 110 is connected between the filter 104 and the drain and return lines 106 and 108. When the valve 112 of the valve/manifold mechanism 110 is in its filtering position (FIG. 1), water is directed from the pool 102 into the pool filter 104 for filtering. When the valve 112 is in its backwash position (FIG. 2), water may be flushed backwards through the pool filter 104 and drained through a backwash outlet 114 rather than returned to the pool 102. Examples of valve/manifold mechanisms include without limitation a two-position, push-pull valve having a sliding disc assembly.

A backwash hose 116 may be attached to the backwash outlet 114. The backwash hose 116 may be a resiliently-flexible hose, for example, that tends to assume a flattened configuration when empty. The backwash hose 116 has a captive end 118 attached to the backwash outlet 114 (e.g., by a hose clamp (not shown)), and a free end 120 through which water is drained. The hose 116 may be formed, for example, of polyvinyl chloride (PVC).

The filtering system 100 may include other features, such as a screen basket trap, heater or chemical treatment devices (e.g., automatic chlorinators, water softener, pH balancing device, etc.) arranged either upstream or downstream of the pool filter 104. As used herein, “upstream” and “downstream” refer to the direction of water flow relative to the pool filter 104.

For example, at least one drain line 106 drains water adjacent the upper surface of the pool 102 through a skimmer (not shown), and a second drain line (not shown) drains water from adjacent the bottom of the pool 102. The drained water then runs through a strainer basket (not shown) to collect larger contaminants. The pump is typically positioned downstream of the strainer basket and upstream of a valve/manifold mechanism 110. In normal use the water is pumped through the valve/manifold mechanism 110 into the filter 104 and back through a different passage of the valve/manifold mechanism 110 to a heater (not shown), where it may be heated before being returned to the pool 102 via the return lines 108. In one exemplary embodiment the return lines have at least two return jets along the sidewall of the pool 102 to facilitate circulation of pool water in the pool 102.

Exemplary Hose Spools

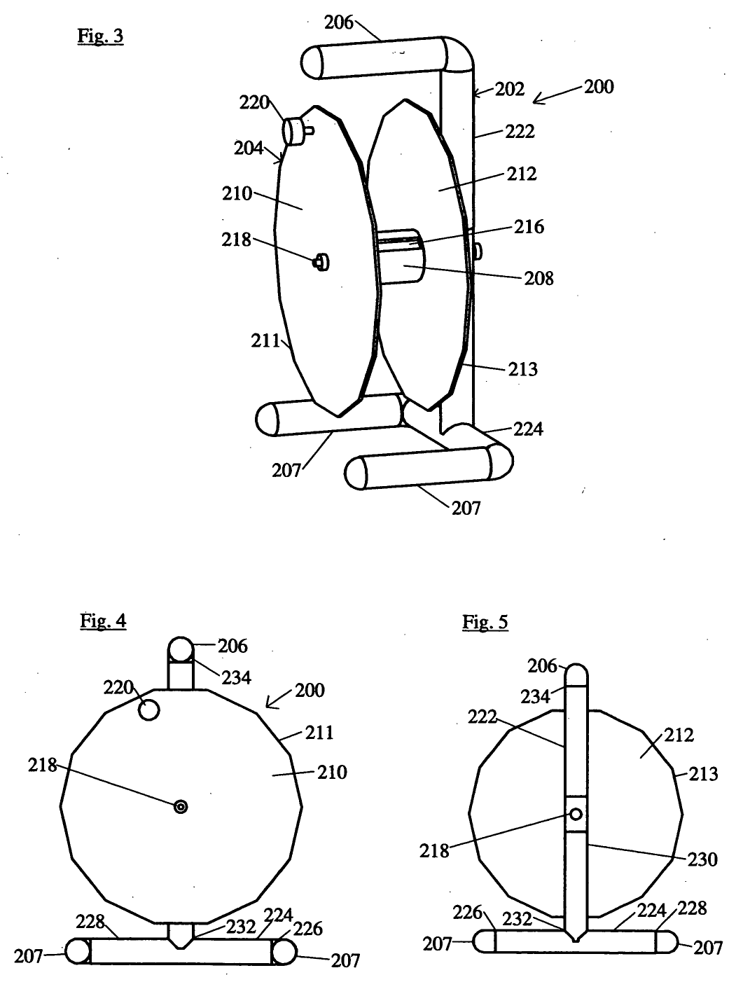

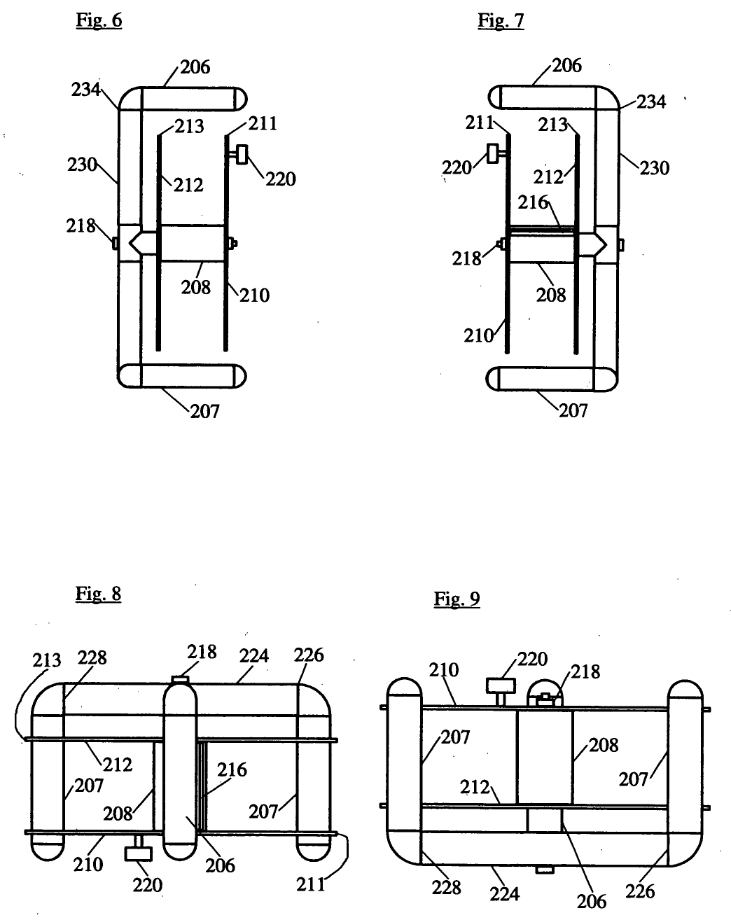

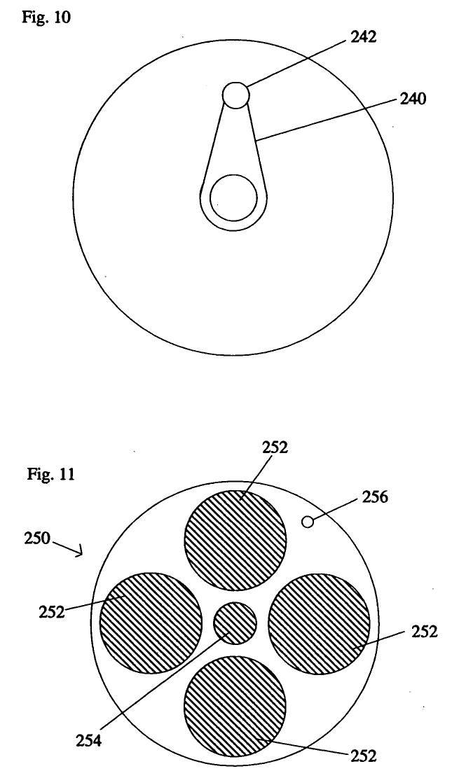

As illustrated in FIG. 2, an exemplary hose spool 200 may be provided for the backwash drain hose 116. As shown in FIGS. 3-9, the exemplary hose spool 200 may generally comprise a frame 202 and a reel 204 upon which the backwash hose 116 may be wound.

A frame handle 206 and feet 207 (e.g., two feet 207) may be provided on the frame 202.

The frame handle 206 is adapted to be manually grasped to carry the hose spool 200. The feet 207 support the hose spool, for example, on the pool deck or ground.

The reel 204 includes a hub 208 mounted for rotation on the frame 202, and two flanges 210, 212 extending radially outwardly from the hub 208. The flanges 210, 212 are spaced apart to define a channel 214 between the flanges 210, 212 for receiving the hose 116. The hub 208 has a slot 216 for releasably receiving the end (e.g., free end 120) of the backwash hose 116, which allows the hose 116 to be wound on the hub 208 when the reel 204 is turned. An axle 218 mounted on the frame 202, and the axle 218 mounts the hub 208 for rotation on the frame 202.

While the peripheral edge 211, 213 of the flanges 210 and 212 are shown as defining a polygon having fourteen sides, it is contemplated that the peripheral edge 211, 213 could have many other configurations with one additional non-limiting embodiment being an edge that defines a circular configuration.

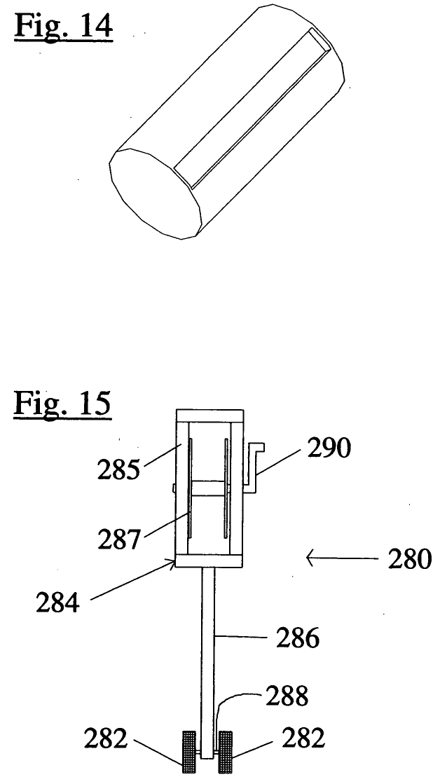

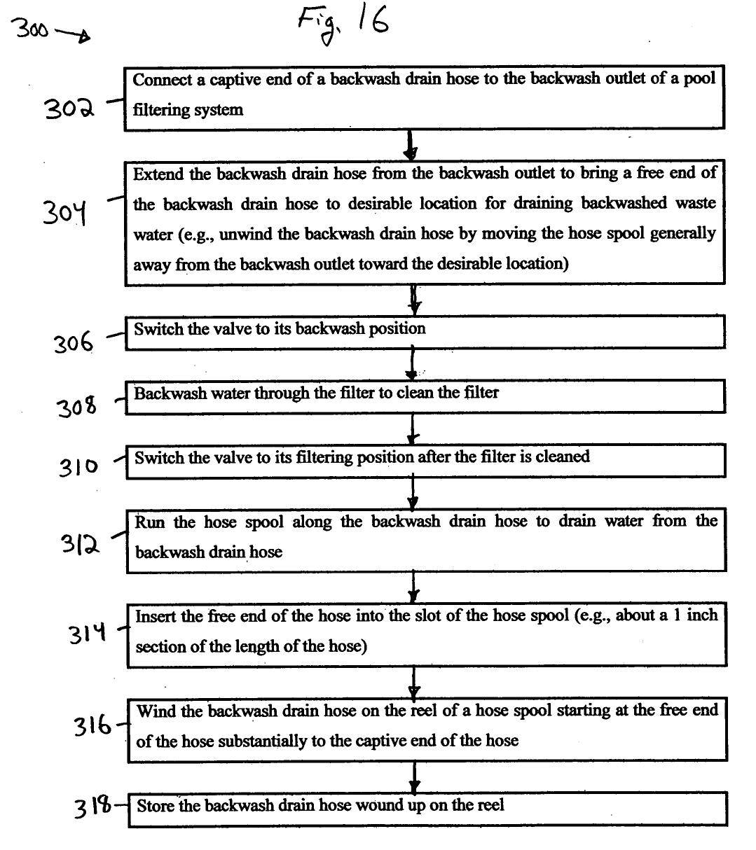

A reel handle may also be provided to facilitate manual turning of the reel 204 to wind the flexible hose 116 on the hub 208. For example, the reel handle may take the form of a knob 220 mounted on one of the two flanges 210 as illustrated in FIGS. 3-4 and 6-9, or a crank arm 240, 290 mounted on the hub of the reel as illustrated in FIGS. 10 and 15. The knob 220 may be mounted to allow rotation of the knob relative to the flange 210, and the knob 242 of FIG. 10 may be mounted to allow rotation on the knob 242 relative to the crank arm 240.

An exemplary embodiment of the frame 202 includes an inverted, generally T-shaped backbone 222 (FIG. 5). This backbone 222 includes: a horizontal section 224 with opposite ends 226, 228 to which the feet 207 are connected; and a vertical section 230 having a lower end 232 connected to middle of the horizontal section 224 and an upper end 234 to which the frame handle 206 is connected. The axle 218 may be mounted on the vertical section 230 intermediate the lower and upper ends 232 and 234 thereof. In a preferred exemplary embodiment, the vertical section 230, horizontal section 224, feet 207 and handle 206 for the frame 202 are formed of interconnected tubular members. Examples include polycarbonate tubing interconnected by tubing connectors and adhesives.

In a preferred exemplary embodiment of the hose spool 200, the hub 208, feet 207 and frame handle 206 are aligned as follows. The hub 208 defines an axis of rotation for the reel 204. Each of the two feet 207 is generally elongate defining a longitudinal direction substantially parallel with the axis of rotation of the hub 208. The frame handle 206 is generally elongate defining a longitudinal direction also substantially parallel with the axis of rotation of the hub 208. It will be appreciated that the frame handle 206 and feet 207 of this preferred exemplary embodiment are also arranged in a substantially parallel manner. This arrangement is believed to facilitate ease of use of the hose spool 200. For example, a user grasping the frame handle 206 tends to line up the axis of rotation relative to the user in such a way as makes it easy to wind and unwind the hose 116.

In an exemplary embodiment of the hose spool 200, the slot 216 has a length extending along the entire length of the hub 208 in a direction substantially parallel with the axis of rotation of the hub 208, although other arrangements are also contemplated, such as a slot (not shown) extending in a spiral manner along the hub. In a preferred exemplary embodiment, however, the slot 216 extends in a direction parallel with the axis of rotation of the hub 208 and has constant width (or fixed gap width) just sufficiently wider than the thickness of the collapsed hose 116 to allow the hose 116 to be inserted in the slot 206. For example, the slot 216 may have a fixed gap width of 0.25-0.75 inches (6-9 mm), preferably about 0.5 inches (13 mm), and a length of 3.5-4.5 inches (9 cm-11.5 cm), preferably 4 inches (10 cm), for use with a hose 116 having a width when flattened of about 3.5 inches (9 cm) and a thickness of about ⅛ inch (3 mm).

Alternative exemplary slots also include slots defined by cushioned or high friction material along the edges of the hub defining the slot, or slots defined by a clamping structure, such as resiliently flexible slot-defining edges that flex to allow insertion of the hose but provide a low clamping or retaining force to help retain the free end of the hose in the slot. Yet another alternative exemplary slot is a slot defined by converging/diverging slot-defining hub edges such that such an alternative slot would be wider adjacent one flange than the other flange.

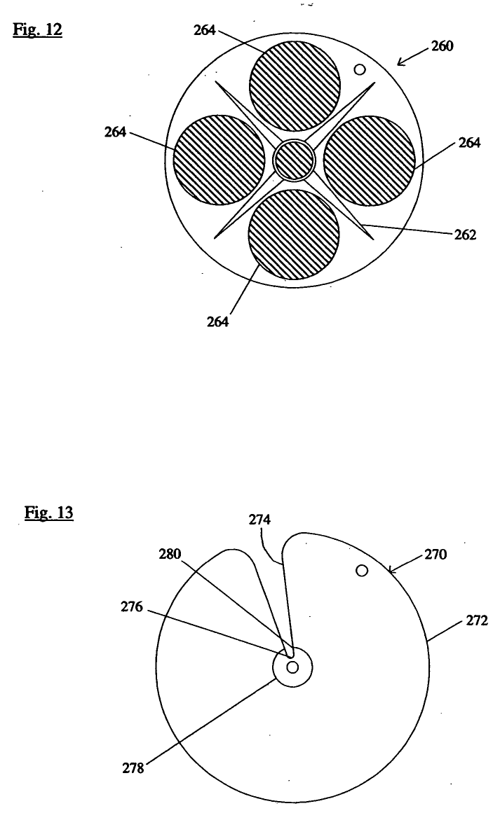

FIG. 11 illustrates an alternative exemplary embodiment of a flange 250 in which large circular openings 252 are formed (e.g., cut or molded) in the flange 250. Four openings 252 are shown although other numbers may be employed. The openings 252 facilitate seeing the slot in the hub when threading the free end into the slot, and seeing hose as it is wound on the reel. The flange 250 includes a central opening 254 for the hub and an opening 256 for a knob or handle. Other configurations of openings are also contemplated, including without limitation irregular shapes, polygons (e.g, triangles, squares, hexagons, pentagons, etc.), and combinations of regular and irregular shapes such as truncated or modified shapes.

FIG. 12 illustrates another alternative exemplary embodiment of a flange 260 in which tapered reinforcing ridges 262 are provided in addition to large circular openings 264. The use of non-tapered reinforcing ridges, other reinforcing structures, or reinforcing ridges in the absence of openings 264 are also contemplated. While the tapered reinforcing ridges 262 are shown as having a generally elongated triangular configuration, variations such as truncated triangles, rounded oblong structures or other shapes are also contemplated. Four reinforcing ridges are shown although more or fewer reinforcing structures may usefully be employed.

FIG. 13 illustrates yet another alternative exemplary embodiment of a flange 270 having a peripheral edge 272 and a channel 274 extending inwardly from the peripheral edge 272. The channel 274 extends inwardly to a closed end 276 radially inwardly of the hub 278. An exemplary hub 278 for use in this embodiment may have an axial direction defined by its axis of rotation, and a length along the axial direction. The hose-receiving slot 280 (similar to slot 216) extends substantially across the entire length of the hub 278, with the slot 280 being aligned with the channel 274 to facilitate insertion of the hose through the channel 274 and into the slot 280. While the channel 274 is shown as having an exemplary tapered configuration with a relatively wider end adjacent the peripheral edge 272 of the flange and a relatively narrower adjacent the closed end 276, other configurations are also contemplated including without limitation a substantially constant width channel, a stepped-down width channel, or any other suitable configuration.

FIG. 15 illustrates yet another alternative exemplary embodiment in which the hose spool 280 includes at least one wheel (e.g., two wheels 282 are shown) rotatably mounted on the frame 284 for rotatably supporting the hose spool 280 on the ground. A common axle 288 may mount the twin wheels shown in FIG. 15 for rotation relative to an elongate support member 286. The exemplary frame 284 further includes a generally rectangularly configured tubular structure 285 bracketing, and providing structural support for, the reel 287. Exemplary hose spool 280 allows the spool 280 to be moved without being carried. Exemplary hose spool 280 also includes a crank-type handle 290 for manual turning of the hub 292.

Alternative wheeled arrangements are also contemplated, including without limitation the addition of a wheel or rotatable sleeve one or both of the feet 207 of the exemplary embodiment of FIGS. 3-9. An exemplary rotatable sleeve on one of the feet 207 could also be used during drainage of the hose following backwashing, for example, by allowing the hose to roll along such a sleeve as the hose spool 200 is pulled along the hose 116 from the captive end 118 to the free end 120 thereof

While the hose spool has been described with reference to a backwash hose, it is also contemplated that it might be employed in connection with other hoses that tend to flatten when empty.

Exemplary Method of Use

An exemplary method 300 is also provided of backwashing a pool filtering system 100. As illustrated in FIG. 16, the exemplary method 300 comprises: (a) connecting a captive end 118 of a backwash hose 116 to the backwash outlet 114 of the pool filtering system 100 (step 302); (b) extending the backwash drain hose 116 from the backwash outlet 114 to bring a free end 120 of the backwash drain hose 116 to desirable location for draining water backwashed through the filter 104 (step 304); (c) switching the valve 112 to its backwash position (FIG. 2) (step 306); (d) backwashing water through the filter 104 to clean the filter 104 (step 308); (e) switching the valve 112 to its filtering position (FIG. 1) after the filter 104 is cleaned by backwashing water through the filter 104 (step 310); (f) running the hose spool 200 along the backwash drain hose 116 to drain water from the backwash drain hose 116 (step 312); (g) inserting the free end 120 of the backwash drain hose 116 into the slot of the hose spool 200 (e.g., about 1 inch (2.5 cm) section of the length of the backwash hose 116) (step 314); (h) winding the backwash drain hose 116 on the reel 204 of a hose spool 200 starting at the free end 120 of the hose 116 substantially to the captive end 118 of the hose 116 (step 316); and (i) storing the backwash drain hose 116 wound up on the reel 204.

The backwash drain hose 116 may be provided or stored wound on the reel 204 of the hose spool 200. Accordingly, in a preferred exemplary embodiment the step 304 of extending the backwash drain hose may be carried out as follows. The hose spool 200 with the wound hose 116 is moved generally away from the backwash outlet 114, with the resulting tension on the hose 116 tending to rotate the reel 204 to unwind the backwash drain hose 116. By so moving the hose spool 200, the free end 120 of the backwash hose 116 is brought to a desirable location for draining backwashed wastewater.

The hose spool 200 also may be used to facilitate draining wastewater from the backwash hose 116 before re-winding the hose 116 on the hose spool 200. For example, after completing the backwashing of water through the filter 104, the hose spool 200 may be placed under the backwash drain hose 116 adjacent its captive end 118 to elevate a portion of the hose 116, and then the hose spool 200 is run along the backwash drain hose 116 to accelerate drainage of water from the backwash drain hose 116. For example, the hose 116 may be place over the hub 208 of the hose spool 200. When the hose 116 is so drained, the backwash drain hose 116 may be wound on the reel 204 of a hose spool 200 from starting at the free end 120 of the hose 160 substantially to the captive end 118 of the hose 116 as discussed with respect to step 316. Among the advantages of this drainage method is the fact that the hose spool 200 is thus brought to the free end 120 of the backwash hose 116 and ready for inserting the free end 120 into the slot 216 in preparation to re-wind the hose 116 on the hose spool 200.

Thus, exemplary embodiments of the apparatus, system and method are disclosed. The disclosed embodiments are presented for purposes of illustration and not limitation.

1. A hose spool for a resiliently-flexible backwash drain hose of the type used to backwash pool filtering systems, the hose spool comprising:
a frame having a frame handle;
a reel having a hub mounted for rotation on the frame and two flanges extending radially outwardly from the hub, the flanges being spaced apart to define a channel between the flanges for receiving a hose, the hub having a slot for releasably receiving the end of the flexible hose to allow the hose to be wound on the hub when the reel is turned.

2. The hose spool according to claim 1 further comprising an axle mounted on the frame, the hub being mounted for rotation on the frame by the axle.

3. The hose spool according to claim 2 wherein at least one of the two flanges has a peripheral edge and a channel extending substantially from the peripheral edge substantially to the hub substantially in alignment with the slot in the hub.

4. The hose spool according to claim 1 wherein the reel further includes a reel handle to facilitate manual turning of the reel to wind the flexible hose on the hub, the reel handle being selected from the group consisting of:
a knob mounted on one of the two flanges; and
a crank arm mounted on the hub of the reel.

5. The hose spool according to claim 1 wherein:
the hub has an axis of rotation;
the frame further comprises at least two feet for supporting the hose spool, each of the two feet being generally elongate defining a longitudinal direction substantially parallel with the axis of rotation of the hub; and
the frame handle is generally elongate defining a longitudinal direction substantially parallel with the axis of rotation of the hub.

6. The hose spool according to claim 5 wherein the frame includes an inverted, generally T-shaped backbone including:
a generally horizontal section with opposite ends to which the feet are connected; and
a generally vertical section having a lower end connected to the horizontal section and an upper end to which the frame handle is connected.

7. The hose spool according to claim 6 further comprising an axle mounted on the vertical section intermediate the lower and upper ends thereof, the hub being mounted for rotation on the frame by the axle; the vertical section, horizontal section, feet and handle for the frame being formed of interconnected tubular members.

8. The hose spool according to claim 1 wherein:
the hub has an axial direction defined by the axis of rotation of the hub, and a length along the axial direction; and
the slot extends substantially across the entire length of the hub.

9. A pool filtering and backwash system for filtering water in a pool, the system comprising:
the hose spool of claim 1;
a pool filter of the type that may be cleaned by backwashing;
a backwash outlet;
a valve connected to the pool filter, the valve having a filtering position in which water is directed from the pool into the pool filter for filtering, and a backwash position in which water flushed backwards through the pool filter is drained through the backwash outlet rather than returned to the pool;
a resiliently-flexible hose that tends to assume a flattened configuration when empty, the resiliently-flexible hose having a captive end attached to the backwash outlet and free end through which water is drained.

10. Apparatus for use in backwashing pool filters, the apparatus comprising:
a resiliently-flexible hose that tends to assume a flattened configuration when empty; and
a hose spool comprising:
a frame having a frame handle;
a reel having a hub mounted for rotation on the frame and two flanges extending radially outwardly from the hub, the flanges being spaced apart to define a channel between the flanges for receiving the hose, the hub having a slot that releasably receives the end of the flexible hose to allow the hose to be wound on the hub when the reel is turned.

11. Apparatus according to claim 10 wherein:
the hose spool further includes an axle mounted on the frame, the hub being mounted for rotation on the frame by the axle;
at least one of the two flanges has a peripheral edge and a channel extending substantially from the peripheral edge substantially to the hub substantially in alignment with the slot in the hub, the channel extending inwardly from the peripheral edge to a closed end of the channel radially inwardly of the hub; and
the reel further includes a reel handle to facilitate manual turning of the reel to wind the flexible hose on the hub.

12. Apparatus according to claim 11 wherein the frame further comprises at least two feet for supporting the hose spool.

13. Apparatus according to claim 12 wherein the hub has an axis of rotation, and each of the two feet is generally elongate defining a longitudinal direction substantially parallel with the axis of rotation of the hub.

14. Apparatus according to claim 13 wherein:
the frame handle is generally elongate defining a longitudinal direction substantially parallel with the axis of rotation of the hub;
the frame includes an inverted, generally T-shaped backbone including:
a generally horizontal section with opposite ends to which the feet are connected; and
a generally vertical section having a lower end connected to the horizontal section and an upper end to which the frame handle is connected;
the hose spool further includes an axle mounted on the vertical section intermediate the lower and upper ends thereof, the hub being mounted for rotation on the frame by the axle; and
the vertical section, horizontal section, feet and handle for the frame are formed of interconnected tubular members.

15. Apparatus according to claim 10 wherein:
the hub has an axial direction defined by the axis of rotation of the hub, and a length along the axial direction; and
the slot extends substantially across the entire length of the hub.

16. A method of backwashing a pool filtering system, the method comprising:
connecting a captive end of a backwash drain hose to the backwash outlet of a pool filtering system having a pool filter that is cleaned by backwashing, the backwash outlet being in fluid communication with the pool filtering system via a valve having a filtering position in which water is directed from the pool into the pool filter for filtering, and a backwash position in which water flushed backwards through the pool filter is drained through the backwash outlet rather than returned to the pool;
extending the backwash drain hose from the backwash outlet to bring a free end of the backwash drain hose to desirable location for draining water backwashed through the filter;
switching the valve to its backwash position and backwashing water through the filter to clean the filter;
switching the valve to its filtering position after the filter is cleaned by backwashing water through the filter; and
winding the backwash drain hose on the reel of a hose spool from starting at the free end of the hose substantially to the captive end of the hose.

17. The method according to claim 16 wherein the backwash drain hose comprises a resiliently-flexible hose that tends to assume a flattened configuration when empty and the reel of the hose spool has a hub with a slot therein, the method further comprising:
inserting the free end of the hose into the slot before winding the backwash drain hose on the reel of a hose spool starting at the free end of the hose substantially to the captive end of the hose.

18. The method according to claim 17 wherein the backwash drain hose is provided wound on the reel of the hose spool, the step of extending the backwash drain hose from the backwash outlet to bring a free end of the backwash drain hose to desirable location for draining water backwashed through the filter includes:
unwinding the backwash drain hose by moving the hose spool generally away from the backwash outlet toward the desirable location for draining water backwashed through the filter.

19. The method according to claim 18 wherein the reel includes two flanges that are spaced apart to receive the backwash drain hose between the flanges, one of the two flanges having a channel to facilitate insertion of the free end of the backwash drain hose into the slot, the step of inserting the free end of the hose into the slot before winding the backwash drain hose on the reel of a hose spool starting at the free end of the hose substantially to the captive end of the hose further including:
inserting the backwash drain hose through the channel to slide the free end of the backwash drain hose into the slot.

20. The method according to claim 19 further comprising storing the backwash drain hose wound up on the reel when not backwashing water through the filter.

21. The method according to claim 20 further comprising running the hose spool along the backwash drain hose after backwashing water through the filter to further drain water from the backwash drain hose before winding the backwash drain hose on the reel of a hose spool from starting at the free end of the hose substantially to the captive end of the hose.
